(19) United States
(12) Patent Application Publication
(10) Pub. No.: US 2017/0371205 A1
(43) Pub. Date: Dec. 28, 2017

(54) DOWNCONVERSION FILM ELEMENT

(71) Applicant: 3M INNOVATIVE PROPERTIES COMPANY, St. Paul, MN (US)

(72) Inventors: Mark J. PELLERITE, Woodbury, MN (US); Gilles J. BENOIT, Minneapolis, MN (US)

(21) Appl. No.: 15/538,537

(22) PCT Filed: Dec. 18, 2015
(86) PCT No.: PCT/US2015/066607

§ 371 Date: Jun. 21, 2017

Related U.S. Application Data
(60) Provisional application No. 62/095,425, filed on Dec. 22, 2014.

(51) Int. Cl. G02F 1/1335; B82Y 20/00; G02B 5/20

(52) U.S. Cl. CPC G02F 1/133603; G02F 1/133514; G02B 5/20; B82Y 20/00; G02F 2001/133614; G02F 2202/36

(57) ABSTRACT

A downconversion film element comprises quantum dots and phosphor, wherein either (a) the quantum dots emit a peak red wavelength in a range from 615 to 660 nm and a FWHM of less than 50 nm, and the phosphor emits a peak green wavelength in a range from 515 to 555 nm and a FWHM of less than 80 nm and has an internal fluorescence quantum yield of 75% or greater or (b) the quantum dots emit a peak green wavelength in a range from 515 to 555 nm and a FWHM of less than 40 nm, and the phosphor emits a peak red wavelength in a range from 615 to 645 nm and a FWHM of less than 80 nm and has an internal fluorescence quantum yield of 75% or greater.

### FIELD

This invention relates to downconversion film elements and to optical constructions and luminaires comprising the downconversion film elements.

### BACKGROUND

Liquid crystal displays (LCDs) are displays that utilize a separate backlight unit and red, green, and blue color filters for pixels to display a color image on a screen. The red, green, and blue color filters respectively separate white light emitted from the backlight unit into red, green, and blue lights. The red, green, and blue color filters each transmit only light of a narrow wavelength band and absorb the rest of the visible spectrum, resulting in significant optical loss. Thus, a high luminance backlight unit is needed to produce an image with sufficient luminance. The range of colors that can be displayed by an LCD device is called color gamut and is determined by the combined spectra of the backlight unit and the color filters of the LCD panel. Thicker, more absorbing color filters result in more saturated primaries and a broader range of color gamut (measured as % NTSC) as well as lower luminance.

A panel's native color gamut can be referred to as the color gamut area that can be achieved in combination with a backlight unit containing white LEDs. Typical white LEDs consist of a blue LED die combined with a yellow YAG phosphor. Native color gamut typically ranges from 40% NTSC for some handheld devices to over 100% NTSC for specialty monitors.

LCD panel constructions with improved color gamut or increased efficacy are desired. Thus LCD panel constructions comprising downconversion film constructions using a combination of green and red quantum dots as the fluorescing elements have recently generated great interest because they can significantly improve % NTSC in LCD panel constructions. Quantum dots, however, are highly sensitive to degradation by moisture and oxygen. In addition, most quantum dot film constructions for LCDs utilize green and red quantum dots based on cadmium, the use of which is regulated in consumer products.

### SUMMARY

In view of the foregoing, we recognize that there is a need in the art for downconversion films with reduced quantum dot content for use in high color gamut displays.

We have discovered that green or red quantum dots in downconversion films can, in some cases, be replaced by green or red phosphors. Replacing green or red quantum dots with green or red phosphors in a film that contains red and green quantum dots can sometimes limit the % NTSC accessible (as compared to the film containing red and green quantum dots), but this “hybrid” downconversion film still provides a significant improvement in color gamut over the current standard of blue LEDs driving a yellow phosphor. In some embodiments, for example, when a red phosphor with a narrow FWHM is used with green quantum dots, % NTSC is actually improved over an all quantum dot system.

Furthermore, other advantages can be realized. Many phosphor chemistries, for example, have excellent performance stability to moisture and oxygen. Also, replacement of at least one of the green quantum dots or the red quantum dots with green phosphor or red phosphor can significantly reduce the cadmium content of the downconversion film. In some cases, for example, when green quantum dots are replaced with green phosphor, cadmium content can be reduced by up to 75%, or when red quantum dots are replaced with red phosphor, cadmium content can be reduced by up to 25%.

In one aspect the present invention provides a downconversion film element comprising quantum dots and phosphor, wherein either (a) the quantum dots emit a peak red wavelength in a range from 615 to 660 nm and a FWHM of less than 50 nm, and the phosphor emits a peak green wavelength in a range from 515 to 555 nm and a FWHM of less than 80 nm and has an internal fluorescence quantum yield of 75% or greater or (b) the quantum dots emit a peak green wavelength in a range from 515 to 555 nm and a FWHM of less than 40 nm, and the phosphor emits a peak red wavelength in a range from 615 to 645 nm and a FWHM of less than 80 nm and has an internal fluorescence quantum yield of 75% or greater.

In another aspect, the present invention provides optical constructions and luminaires comprising the downconversion film elements.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic side elevation view of an illustrative optical construction;

FIGS. 2A and 2B are graphs showing luminance and color point data for the films of Example 1.

FIG. 3 is a graph showing system efficiency versus color gamut for the systems of Example 3.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The term “light recycling element” refers to an optical element that recycles or reflects a portion of incident light and transmits a portion of incident light. Illustrative light recycling elements include reflective polarizers, micro-structured films, metallic layers, multi-layer optical film and combinations thereof.

The term “% NTSC” refers to the quantification of color gamut. NTSC stands for the National Television System Committee. In 1953 NTSC defined a color television standard colorimetry with the following CIE color coordinates:

| | | |
|---|---|---|
| primary red | 0.67 | 0.33 |
| primary green | 0.21 | 0.71 |
| primary blue | 0.14 | 0.08 |
| white point (CIE Standard illuminant C) | 0.310 | 0.316 |

The (color) gamut of a device or process is the portion of the CIE color space that can be reproduced. To quantify the color gamut of an LCD display, the area of the triangle defined by its three primaries (i.e., red, green, blue color filters on) is normalized to the area of the standard NTSC triangle and reported as % NTSC.

The phrase “native color gamut” refers to the color gamut area that can be achieved in combination with a backlight unit containing white LEDs.

The term “FWHM” stands for Full Width at Half Maximum. As the name indicates, it is given by the distance between points on the curve at which the function reaches half its maximum value and is approximately symmetric about its maximum value.

The disclosure relates to the design of LCD displays that deliver a target color gamut area (measured as % NTSC) using an LCD panel of lower native color gamut by at least 10% combined with a backlight unit containing blue LEDs and a downconversion film element comprising green phosphor and red quantum dots, resulting in much improved system luminance, among other aspects. The use of blue LEDs and green phosphor and red quantum dots in a backlight to generate a white spectrum with narrow blue, green and red emission peaks can deliver a better trade-off between color gamut and luminance than traditional devices that utilize white LEDs. In fact, when using a backlight of the invention, a target color gamut can be achieved using an LCD panel whose native color gamut is at least 10% lower, resulting in higher luminance output and/or lower power consumption. While the present disclosure is not so limited, an appreciation of various aspects of the disclosure will be gained through a discussion of the examples provided below.

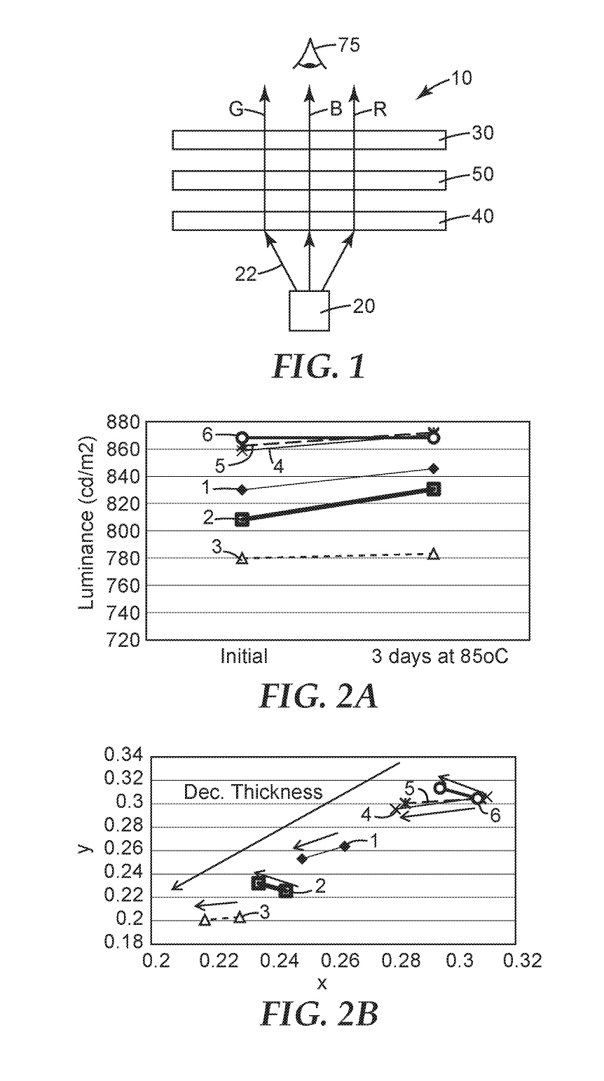

FIG. 1 is a schematic cross-sectional view of an illustrative optical construction 10. The optical construction 10 includes a blue light source 20 emitting blue light 22, and a liquid crystal display panel 30 having a set of red, blue and green color filters and having a native color gamut being less than the target color gamut by at least 10%. The construction 10 also includes a hybrid downconversion element 40 including a plurality of quantum dots and phosphor, which is optically between the blue light source 20 and the liquid crystal display panel 30.

Downconversion element 40 has either (a) quantum dots emitting a peak red wavelength in a range from 615 to 660 nm and a FWHM of less than 50 nm, and phosphor emitting a peak green wavelength in a range from 515 to 555 nm and a FWHM of less than 80 nm and having an internal fluorescence quantum yield of 75% or greater or (b) quantum dots emitting a peak green wavelength in a range from 515 to 555 nm and a FWHM of less than 40 nm, and phosphor emitting a peak red wavelength in a range from 615 to 645 nm and a FWHM of less than 80 nm and having an internal fluorescence quantum yield of 75% or greater.

A viewer 75 faces a viewing or display side of the optical construction 10 and can discern the green light G, red light R and blue light B emitted from the optical construction 10. An optional light recycling element 50 can be optically between the hybrid downconversion film element 40 and the liquid crystal display panel 30.

In one or more embodiments, the blue light source 20 and the downconversion film element 40 can be integrated into a single element such as a backlight forming a quantum dot/phosphor hybrid backlight, for example. In one embodiment, the hybrid downconversion film element 40 can be incorporated into a diffuser film of the backlight or replace the diffuser film of a backlight. Thus the quantum dot/phosphor hybrid backlight can be a “drop-in” backlight solution to any display or LCD display.

The blue light source 20 emitting blue light 22 can be any useful blue light source. In one or more embodiments the blue light source 20 is a solid state element such as a light emitting diode, for example. In one or more embodiments the blue light source 20 emits blue light 22 at a wavelength in a range from 440 to 460 nm and an FWHM of less than 25 nm or less than 20 nm.

The hybrid downconversion film element refers to a layer or film of resin or polymer material that includes a plurality of (red or green) quantum dots or quantum dot material and (red or green) phosphor. In many embodiments, this material is sandwiched between two barrier films. Suitable barrier films include plastic, glass or dielectric materials, for example.

The hybrid downconversion film element can include one or more populations of quantum dot material and one or more populations of phosphors. Exemplary quantum dots or quantum dot material emit red light or green light upon down-conversion of blue primary light from the blue LED to secondary light emitted by the quantum dots. Exemplary phosphors emit green or red light upon down-conversion of blue primary light from the blue LED to secondary light emitted by the phosphor. In some embodiments, quantum dots or quantum dot material that emit green light upon down-conversion of blue primary light from the blue LED to secondary light emitted by the quantum dots may optionally be included with green emitting phosphors. Similarly, in some embodiments, quantum dots or quantum dot material that emit red light upon down-conversion of blue primary light from the blue LED to secondary light emitted by the quantum dots may optionally be included with red emitting phosphors. The respective portions of red, green, and blue light can be controlled to achieve a desired white point for the white light emitted by the display device incorporating the hybrid quantum dot/phosphor film element.

Exemplary quantum dots for use in integrated quantum dot constructions described herein include CdSe or ZnS. Suitable quantum dots for use in integrated quantum dot constructions described herein include core/shell luminescent nanocrystals including CdSe/ZnS, InP/ZnS, PbSe/PbS, CdSe/CdS, CdTe/CdS or CdTe/ZnS. In exemplary embodiments, the luminescent nanocrystals include an outer ligand coating and are dispersed in a polymeric matrix. Quantum dots and quantum dot material are commercially available from Nanosys Inc., Milpitas, Calif. In many embodiments, the refractive index of the quantum dot film element is in a range from 1.4 to 1.6, or from 1.45 to 1.55. Exemplary green phosphors that are suitable for use in the present invention include EMD Chemicals SSL-LD-130702210 (green phosphor that emits around 525 nm, has an FWHM of 70 nm and a quantum yield was 90%), Merck SGA 524 100 (green phosphor that emits around 524 nm, has an FWHM of 66 nm and a quantum yield of 90%), Mitsui G535 (green phosphor that emits around 535 nm, has an FWHM of 47 nm and a quantum yield of 85%) and Mitsui G532 (green phosphor that emits around 530 nm, has an FWHM of 50 nm and a quantum yield of 85%).

Other suitable green phosphors include the following non-limiting examples: (i) various europium-doped orthosilicates such as SrBaSiO₄:Eu(+2), which can be prepared according to methods described in U.S. Pat. No. 3,505,240 (Barry), and SrₓBa_{y}Ca_{z}SiO₄:Eu(+2), B where B is selected from Ce, Mn, Ti, Pb, and Sn as described in U.S. Pat. No. 6,982,045 (Menkara et al.). Commercially available materials from this class include Isiphor™ BOSE SGA 524 100, obtainable from EMD Chemicals, Waltham, Mass., and BUVG02 obtainable from PhosphorTech Corporation, Kennesaw, Ga.; (ii) europium-doped strontium thiogallate, SrGa₂S₄:Eu(+2), such as that commercially available from Lorad Chemical Corporation, St. Petersburg, Fla. (http://loradchemical.com/news/strontium-thiogallate-phosphor.html); (iii) europium- and manganese-doped barium magnesium aluminum oxide, BaMg₂Al₁₆O₂₇:Eu, Mn such as KEMK63M/F-U1 commercially available from Phosphor Technology Ltd., Stevenage, Herts, UK; and rare earth-doped nitridosilicates, which may be prepared according to methods described in R.-J. Xie et al, Materials 2010, 3, 3777-93. One example of a commercially available suitable nitride green phosphor is HTG540 from PhosphorTech Corporation, Kennesaw, Ga.

Red phosphors that are suitable for use in the present invention include the following non-limiting examples: (i) Mn(+4) doped phosphors such as K₂SiF₆:Mn(+4) which may be prepared according to methods described in A. G. Paulusz, J. Electrochem. Soc. Sol. St. Sci. Technol. 1973, 120, 942-7; 3.5MgO.0.5MgF₂.GeO₂:Mn(+4) which may be prepared according to methods described in L. Thorington, J. Opt. Sci. Amer. 1950, 40, 579-83; and 2.7MgO.0.5MgF₂.0.8SrF₂. GeO₂:Mn(+4) which may be prepared according to methods described in S. Okamoto and H. Yamamoto, J. Electrochem. Soc. 2010, 157, J59-63; (ii) europium-doped calcium sulfide, CaS:Eu(+2), such as that commercially available as Type FL63/S-D1 from Phosphor Technology Ltd., Stevenage, Herts, UK; and (iii) europium(+3)-doped phosphors such as Gd₂O₂S:Eu(+3), commercially available as UKL63/F-U1 from Phosphor Technology Ltd., Stevenage, Herts, UK; Sr_{1.7}Zn_{0.3}CeO₄:Eu(+3) which can be prepared according to methods described in H. Li et al, ACS Appl. Mater. Interf. 2014, 6, 3163-9; Me-activated fluoride microcrystals such as K₂TiF₆, K₂ SiF₆, NaGdF₄ and NaYF₄ which can be prepared according to methods described in Zhu, H. et al. Highly efficient non-rare-earth red emitting phosphor for warm white light-emitting diodes. Nat. Commun. 5:4312 doi: 10.1038/ncomms5312 (2014); and complex fluoride phsosphors activated with Mn⁴⁺ such a K₂[SiF₆]:Mn⁴⁺, K₂[TiF₆]:Mn⁴⁺, K₃[ZrF₇]:Mn⁴⁺, Ba_{0.65}Zr_{0.35}F_{2.70}:Mn⁴⁺, Ba[TiF₆]:Mn⁴⁺, K₂[SnF₆]:Mn⁴⁺, Na₂[TiF₆]:Mn⁴⁺ and Na₂[ZrF₆]:Mn⁴⁺ described in US Patent Application Pub. No. US 2006/0169998 (Radkov et al.).

It has been discovered that the selection of specific red or green emitting quantum dot populations having a specified peak emission and FWHM forming the quantum dot material and specific green or red phosphors having a specified peak emission and FWHM can improve the color gamut of a liquid crystal display panel. In one or more embodiments, the optical construction can specify a target color gamut and an LCD panel having a native color gamut being less than the target color gamut by at least 10% or at least 15% or at least 20% can be utilized with either (a) specifically chosen red emitting quantum dot populations having a specified peak emission and FWHM forming the quantum dot material and specifically chosen green emitting phosphors having a specified peak emission and FWHM and internal fluorescence quantum yield or (b) specifically chosen green emitting quantum dot populations having a specified peak emission and FWHM forming the quantum dot material and specifically chosen red emitting phosphors having a specified peak emission and FWHM and internal fluorescence quantum yield.

In one or more embodiments, the hybrid quantum dot/phosphor film element includes quantum dots emitting a peak red wavelength in a range from 615 to 660 nm and an FWHM of less than 50 nm and one or more green phosphors emitting a peak green wavelength in a range from 515 to 555 nm and an FWHM of less than 80 nm and having an internal fluorescence quantum yield of 75% or greater. In some embodiments, the green phosphors have a FWHM of less than 70 nm, 60 nm or 50 nm and have an internal florescence quantum yield of 80%, 85%, 90% or greater.

In one or more embodiments, the hybrid quantum dot/phosphor film element includes quantum dots emitting a peak green wavelength in a range from 515 to 555 nm and an FWHM of less than 40 nm and one or more red phosphors emitting a peak red wavelength in a range from 615 to 645 nm and an FWHM of less than 80 nm and having an internal fluorescence quantum yield of 75% or greater. In some embodiments, the red phosphors have a FWHM of less than 70 nm, 60 nm, 50 nm, 40 nm, 30 nm, 20 nm, or 10 nm and have an internal florescence quantum yield of 80%, 85%, 90% or greater. In some embodiments, the red phosphor provides better performance than red quantum dots because of a very narrow FWHM.

In one or more embodiments, the LCD panel has a native color gamut in a range from 35% to 45% NTSC, and the optical construction comprising the hybrid quantum dot/phosphor film element of the invention then achieves a color gamut of at least 50% NTSC.

In one or more embodiments, the LCD panel has a native color gamut in a range from 45% to 55% NTSC, and the optical construction comprising the hybrid quantum dot/phosphor film element of the invention then achieves a color gamut of at least 60% NTSC.

In one or more embodiments, the LCD panel has a native color gamut in a range from 55% to 65% NTSC, and the optical construction comprising the hybrid quantum dot/phosphor film element of the invention then achieves a color gamut of at least 70% NTSC.

In one or more embodiments, the LCD panel has a native color gamut in a range from 65% to 75% NTSC, and the optical construction comprising the hybrid quantum dot/phosphor film element of the invention then achieves a color gamut of at least 80% NTSC.

In one or more embodiments, the LCD panel has a native color gamut in a range from 75% to 85% NTSC, and the optical construction comprising the hybrid quantum dot/phosphor film element of the invention then achieves a color gamut of at least 90% NTSC.

In one or more embodiments, the LCD panel has a native color gamut in a range from 85% to 95% NTSC, and the optical construction comprising the hybrid quantum dot/phosphor film element of the invention then achieves a color gamut of at least 100% NTSC.

Illustrative light recycling elements include reflective polarizers, micro-structured films, metallic layers, multi-layer optical film and combinations thereof. Micro-structured films include brightness enhancing films. The multilayer optical film can selectively reflect one polarization of light (e.g., a reflective polarizer described herein) or can be non-selective with respect to polarization. In many examples the light recycling element reflects or recycles at least 50% of incident light, or at least 40% or incident light or at least 30% of incident light. In some embodiments the light recycling element includes a metallic layer.

The reflective polarizer can be any useful reflective polarizer element. A reflective polarizer transmits light with a single polarization state and reflects the remaining light. Illustrative reflective polarizers include birefringent reflective polarizers, fiber polarizers and collimating multilayer reflectors. A birefringent reflective polarizer includes a multilayer optical film having a first layer of a first material disposed (e.g., by coextrusion) on a second layer of a second material. One or both of the first and second materials may be birefringent. The total number of layers may be tens, hundreds, thousands or more. In some exemplary embodiments, adjacent first and second layers may be referred to as an optical repeating unit. Reflective polarizers suitable for use in exemplary embodiments of the present disclosure are described in, e.g., U.S. Pat. Nos. 5,882,774, 6,498,683, and 5,808,794, which are incorporated herein by reference. Any suitable type of reflective polarizer may be used for the reflective polarizer, e.g., multilayer optical film (MOF) reflective polarizers; diffusely reflective polarizing film (DRPF), such as continuous/disperse phase polarizers; wire grid reflective polarizers; or cholesteric reflective polarizers.

Brightness enhancing films generally enhance on-axis luminance (referred herein as “brightness”) of a lighting device. Brightness enhancing films can be light transmissible, microstructured films. The microstructured topography can be a plurality of prisms on the film surface such that the films can be used to redirect light through reflection and refraction. The height of the prisms can range from about 1 to about 75 micrometers. When used in an optical construction or display such as that found in laptop computers, watches, etc., this microstructured optical film can increase brightness of an optical construction or display by limiting light escaping from the display to within a pair of planes disposed at desired angles from a normal axis running through the optical display. As a result, light that would exit the display outside of the allowable range is reflected back into the display where a portion of it can be “recycled” and returned back to the microstructured film at an angle that allows it to escape from the display. The recycling is useful because it can reduce power consumption needed to provide a display with a desired level of brightness.

Brightness enhancing films include microstructure-bearing articles having a regular repeating pattern of symmetrical tips and grooves. Other examples of groove patterns include patterns in which the tips and grooves are not symmetrical and in which the size, orientation, or distance between the tips and grooves is not uniform. Examples of brightness enhancing films are described in Lu et al., U.S. Pat. No. 5,175,030, and Lu, U.S. Pat. No. 5,183,597, incorporated herein by reference.

The hybrid downconversion film elements of the invention are also useful in other applications. For example, the hybrid downconversion film elements can be used in lighting applications such as, for example, luminaires and lighting assemblies for color tuning and/or color rendering of LED lighting.

Luminaires typically include a light source and an optical component such as a light guide or a diffuser. The optical component typically operates to direct light from the light source out of the luminaire. The hybrid downconversion film elements of the present invention can be used in luminaires that utilize blue LEDs as the light source. The downconversion film can be disposed on at least a portion of an optical component that is adapted to be optically coupled to the blue LED light source. In some embodiments, the optical component is a light guide, diffuser or a transflector. In some embodiments, the luminaire may include a back reflector. The back reflector may be a specular reflector or it may be a semi-specular reflector. In some embodiments, the luminaire may include a transflector as described in PCT Publication WO 2015/126778 (Wheatley et al.).

Some of the advantages of the disclosed quantum dot/phosphor optical constructions are further illustrated by the following examples. The particular materials, amounts and dimensions recited in this example, as well as other conditions and details, should not be construed to unduly limit the present disclosure.

### EXAMPLES

Objects and advantages of this invention are further illustrated by the following examples, but the particular materials and amounts thereof recited in these examples, as well as other conditions and details, should not be construed to unduly limit this invention.

### Example 1

Materials used in this example included the following:

The green phosphor SSL-LD-130702210 was obtained from EMD Chemicals, Waltham, Mass. and used as received. Spectroscopic data on this phosphor dispersed in UV-cured acrylic resins (measured using a Hamamatsu Quantaurus-QY fluorescence spectrometer available from Hamamatsu Corp., Bridgewater N.J.) were as follows: Peak emission wavelength was 525 nm (excitation at 440 nm), emission peak full width at half-maximum (FWHM) was 70 nm, and internal quantum yield was 90%.

Red quantum dot concentrate 1964-01 was obtained from Nanosys (Milpitas, Calif.) and used as received. This CdSe-based material was characterized by a peak emission wavelength of approximately 620 nm (excitation 440 nm), FWHM of approximately 44 nm, and internal quantum yield of approximately 90%.

Epon 828 epoxy resin, tert-butylaminoethyl methacrylate (TBAEMA), SR348 (ethoxylated(2) bisphenol A dimethacrylate), SR340 (2-phenoxyethyl methacrylate) and Darocure 4265 photoinitiator were used as received. (Epon 828 was obtained from Momentive, Columbus Ohio SR348 and SR340 were obtained from Sartomer, Exton Pa. Darocure 4265 was obtained from BASF Corp., Wyandotte Mich.)

Matte barrier-coated PET film, 2 mil (51 micron) in thickness, FTB3-M-1215 was obtained from 3M Company (St. Paul, Minn.).

A UV-curable resin formulation was prepared by mixing 545 g premix (containing 60 wt % Epon 828 and 40 wt % TBAEMA), 296.6 g SR348, 149.4 g SR340, and 9.9 g Darocure 4265. Ingredients were combined in a screwtop amber jar and turned on a roller until uniformly mixed. To 768.7 g of this resin were added 10.0 g red quantum dot concentrate 1964-01 and 221.3 g SSL-LD-130702210 green phosphor. This mixture was stirred to disperse the phosphor, and the mixture was transferred to a 1-liter syringe in a glovebox under anhydrous nitrogen atmosphere to protect the quantum dots from degradation by exposure to water and oxygen.

The above mixture was coated between two layers of matte barrier-coated PET film on a tandem coating line using a 4-in (10.2 cm) width die coater enclosed in a purge box under nitrogen (27 ppm oxygen) at a line speed of 10 ft/min (3 m/min). Resin flow rate was adjusted so as to produce film thicknesses in the range of 6-9 mil (0.15 mm to 0.23 mm). Coatings were cured using a blue LED panel emitting at 395 nm. Other line conditions were as follows: a slot extrusion die with ¼ face slot rear fed die, 20 mil (0.51 mm) shim, 7 mil (0.18 mm) lamination gap, 7 mil (0.18 mm) coating gap, and UV LED lamp power 12 amps. A total of six coating samples at different thicknesses were obtained. Transmission, haze, and clarity of the samples was measured (using a Hazegard Plus haze meter from BYK-Gardner, Columbia Md.), and luminance and x-y color point (measured using methods and equipment as described in the examples of WO 2014/123836 (Benoit et al.), which is herein incorporated by reference) before and after aging in an oven at 85° C. for 3 days. Data are shown in Table 1 and FIGS. 2A and 2B. Fluorescence quantum yields using excitation at 440 nm gave values of 78-79% for all samples. Attempts to measure peel strength in a t-peel measurement led to tearing of the barrier film, indicating that resin adhesion to substrate was excellent.

Table 1 shows data for the hybrid green phosphor/red quantum dot films prepared in Example 1. Data listed for the control sample are for a similar film prepared as with the other films except using green quantum dots in place of green phosphor. The green quantum dots were obtained as a concentrate, G1964-01 from Nanosys (Milpitas, Calif.) and used as received. FIGS. 2A and 2B show changes in luminance and color point data for hybrid green phosphor/red quantum dot films upon aging 3 days at 85° C.

TABLE 1

| | | | | | Luminance, Color Point Data | | | | | |
|---|---|---|---|---|---|---|---|---|---|---|
| | Final | Transmission, | | | Initial | | | 3 days at 85° C. | | |
| | Thickness | Haze, Clarity | | | Luminance | | | Luminance | | |
| Coating ID | (mil) | % T | Haze | Clarity | (cd/m2) | X | Y | (cd/m2) | X | Y |
| 1 | 7.62 | 85.2 | 76.1 | 23.7 | 830.06 | 0.2637 | 0.2505 | 845.54 | 0.2497 | 0.253 |
| 2 | 6.80 | 86.3 | 71.4 | 24.5 | 808.25 | 0.2444 | 0.2254 | 830.55 | 0.2354 | 0.2321 |
| 3 | 6.16 | 87.8 | 64.6 | 25.3 | 779.89 | 0.2292 | 0.2031 | 783.25 | 0.2177 | 0.2008 |
| 4 | 8.91 | 79.7 | 88.3 | 21.3 | 858.81 | 0.3106 | 0.306 | 870.61 | 0.2804 | 0.2955 |
| 5 | 8.86 | 79.2 | 88.9 | 20.9 | 862.45 | 0.3086 | 0.3044 | 872.06 | 0.2837 | 0.3004 |
| 6 | 9.02 | 79.6 | 88 | 21.4 | 868.17 | 0.3075 | 0.3045 | 868.13 | 0.2951 | 0.3134 |
| Control | 8.39 | 81.3 | 101 | 4.2 | 800.43 | 0.235 | 0.2077 | 816.31 | 0.24 | 0.2092 |

As seen in Table 1 and FIG. 2A, luminance for the hybrid phosphor/quantum dot system was similar to an all-quantum dot control when considering samples at approximately the same color point (2 and 3). Differences in haze and clarity between samples 1-6 and the control can likely be attributed to use of different resin systems, as the control utilized a thermally-cured epoxy resin system. Also, upon thermal aging, color points seem to shift toward the blue, suggesting differential aging of the phosphor and the quantum dots.

Measurement of elemental cadmium content on several films from Table 1 was determined using Inductively Coupled Plasma-Atomic Emission Spectroscopy (ICP-AES). The instrument used for elemental analysis was a Perkin Elmer Optima 4300DV ICP optical emission spectrophotometer. The cadmium content in the films was in the range of 70-73 ppm, which is much lower than the content in most quantum dot films. It is also below the Restriction of Hazardous Substances (RoHS) standard of 100 ppm.

Finally, the hybrid and control films exhibited different behavior with respect to formation of edge defects upon prolonged aging at room temperature. Oxygen and water ingress at the unprotected edges of the films produced complete loss of emission in a band around the film edge for the all-quantum dot film, due to loss of fluorescence activity in both the green and red fluorescers, while the hybrid system showed a shift in emission color due to stability of the green fluorescer and loss of the red.

### Example 2

A quantum dot display was modeled as follows. Using the MATLAB software package (available from MathWorks, Natick Mass.) and methods described in the examples of WO 2014/123724 (Benoit et al.), which is herein incorporated by reference, a computer model of the display system was prepared. The system's primary light source was a blue LED. The blue LED illuminated a down-converting film consisting of red- and green-emitting quantum dots, or a hybrid construction containing green phosphor and red quantum dots. The LED and fluorescers (either quantum dots or phosphors) were characterized by their intrinsic full-width-at-half-maximum (FWHM). For the blue LED, FHWM was 18 nm at 445 nm. For the green and red quantum dots, the FWHM values were 34 nm and 39 nm at 535 nm and 625 nm, respectively.

Commercially available green phosphors utilized in this work were as follows: Isiphor™ SGA 524 100 and Isiphor™ LGA 553 100 (available from EMD Chemicals, Waltham, Mass.); G532A and G535A (available from Oak-Mitsui Technologies, Hoosick Falls, N.Y.). Also included as a comparative example was a broadband yellow phosphor, Isiphor™ YGA 577 200 (available from EMD Chemicals.)

For the green phosphors SGA 524 100, G532A, and G535A, and the yellow phosphor YGA 577 200, spectral parameters (fluorescence quantum yield QY, emission band FWHM, and emission band peak wavelength λₘₐₓ) were measured on coatings of 20 wt % phosphor in a UV-curable acrylic resin with refractive index 1.515 on PET film using a Quantaurus-QY fluorescence spectrophotometer operating at an excitation wavelength of 440 or 450 nm. For the LGA 553 100 green phosphor, FWHM and λₘₐₓ values were taken from the EMD Chemicals product information sheet, and quantum yield was assumed to be 90%. Spectral parameters for the green and yellow phosphors are summarized in Table 2 below.

TABLE 2

| Phosphor | λₘₐₓ (nm) | FWHM (nm) | QY (%) |
|---|---|---|---|
| SGA 524 100 | 525 | 69 | 91 |
| G532A | 530 | 50 | 86 |
| G535A | 535 | 48 | 85 |
| LGA 553 100 | 520 | 102 | 90 |
| YGA 577 200 | 536 | 115 | 89 |

The emission wavelengths of the LED and fluorescers were used in optimizations designed to maximize the displayed color gamut. Specifically, the peak wavelengths of the blue LED and quantum dots were optimized (variables) to maximize performance while the peak wavelengths of the phosphor materials were chosen from commercially available materials (fixed). That process was constrained to closely approximate or augment an appropriate standard color space (DCI-P3 color space with 96% NTSC color gamut: xb=0.150, yb=0.060, xg=0.265, yg=0.690, xr=0.680, yr=0.320; or Adobe RGB color space with 95.5% NTSC color gamut: xb=0.150, yb=0.060, xg=0.210, yg=0.710, xr=0.640, yr=0.330).

The relative proportion of red and green fluorescers was then tuned to deliver a target white point (D65 white point: xw=0.313, yw=0.329). The model also included two BEF films (3M Brightness Enhancement Films TBEF2-GT and TBEF2-GMv5 available from 3M Company, St. Paul Minn.) positioned above the quantum dot film. One BEF film had prisms running along a horizontal axis and the second had prisms running perpendicularly along the vertical axis. The BEF films were modeled as isosceles prism films with 24 micron pitch. Also included in the stack was a 3M APFv3 reflective polarizer (also available from 3M Company). Then, above the crossed BEF films and reflective polarizer, the model included a standard LCD panel with measured native color gamut of 51%, 54%, 61%, 67%, 71%, 74%, or 90% NTSC. A diffuse low brightness reflector with a thickness of 160 μm was used as a back reflector on the non-emitting side of the display. The white LED display was modeled in a similar fashion. The only variable that was adjusted was the ratio of blue light from the LED die to yellow light from the YAG phosphor to match the white point of the quantum dot display as closely as possible. Electrical-to-optical efficiencies were assumed to be 46% for the blue LED and 40% for the white LED. These figures include losses due to light scattering back into the die.

Color gamut was calculated as the ratio of the area of the color space of the display (defined by the primaries CIE coordinates xb, yb, xg, yg, xr, yr) to the area of the 1953 color NTSC triangle. The CIE color coordinates of each blue, green and red primaries were calculated using the combined spectra of the backlight unit and the corresponding color filter.

Results from the modeling approach discussed above demonstrated that the hybrid system can deliver good performance in a display when combined with a commercially available 74% NTSC panel (measured from an iPad 3 device, available from Apple Inc.) with color gamut size >90% of the target gamut color space for both DCI-P3 and Adobe RGB and close to 90% coverage. Near 100% coverage could be achieved by optimizing the design of the color filters. Compared with the all-Cd all-quantum dot film, color gamut size and coverage were down about 5% and about 10% for the DCI-P3 and Adobe RGB targets, respectively, when using commercially available green phosphors. These figures compare very favorably with the approximately 20-25% decreases for the standard YAG LED case relative to the all-quantum dot construction. The performance of the broader-emission band green phosphor in Comparative Sample 1, on the other hand, is only marginally better than the Comparative Sample 3 reference. Computational results on the all quantum dot and hybrid phosphor/quantum dot films discussed above are summarized in Table 3 below along with comparative data for the reference system (blue LED+YAG).

TABLE 3

| | | | Color Gamut | | |
|---|---|---|---|---|---|
| | | | | % | % |
| | | Color | % | Relative | Coverage |
| Ex # | Fluorescers | Space | NTSC | to Target | of Target |
| 1 | SGA524 + Red | Adobe | 87.1 | 91.1 | 86.3 |
| | QD | RGB | | | |
| | | DCI-P3 | 87.1 | 90.6 | 90.0 |
| 2 | G532A + Red QD | Adobe | 90.3 | 94.5 | 86.9 |
| | | RGB | | | |
| | | DCI-P3 | 90.3 | 94.0 | 91.6 |
| 3 | G535A + Red QD | Adobe | 88.5 | 92.6 | 84.1 |
| | | RGB | | | |
| | | DCI-P3 | 88.5 | 92.1 | 89.5 |
| Comp 1 | LGA553 + Red | Adobe | 79.3 | 83.0 | 80.1 |
| | QD | RGB | | | |
| | | DCI-P3 | 79.3 | 82.6 | 82.6 |
| Comp 2 | Green QD + Red | Adobe | 98.6 | 103.2 | 95.6 |
| | QD | RGB | | | |
| | | DCI-P3 | 92.1 | 95.9 | 93.1 |
| Comp 3 | Yellow YGA577 | Adobe | 73.3 | 76.7 | 76.2 |
| | only | RGB | | | |
| | | DCI-P3 | 73.3 | 76.3 | 76.2 |

### Example 3

Color gamut comes at the cost of system efficacy. This trade-off is inherent to LCD technology but can be improved with the use of narrow emission sources like quantum dots. This was demonstrated in the following computational example.

System efficacy was computed as follows.

First, the output spectrum of the display was determined by the combined spectra of the blue LEDs and quantum dot film (after recycling in the backlight unit including absorption losses, Stokes losses and quantum efficiency losses), modified (i.e., multiplied point by point) by the spectrum of the color filters and by the photopic luminosity function that represents color sensitivity of the human eye. Then the resulting spectrum was integrated across the range of visible wavelengths (400 to 750 nm) to produce a combined output luminous flux (in lumens). Next, just the spectrum of the blue LED (before down-conversion) was integrated, also across the range of visible wavelengths, to determine the blue LED optical power (in Watts). The ratio of the combined luminous flux to the blue LED optical power was computed as optical efficacy (in lumens/Watt). This ratio was then multiplied by the electrical efficiency of the blue LED (assumed to be 46%). The resulting quantity provided a measure of efficacy in lumens per plug-watt. In this study, the efficacy of the reference white LED was about 105 lm/W and the Internal Quantum Efficiency (IQE) of the down-converting material was equal to 90% for the quantum dots (as specified by Nanosys) and 95% for the phosphor (actual IQE values range from 85% to 99% depending on the specific peak wavelength and the manufacturer).

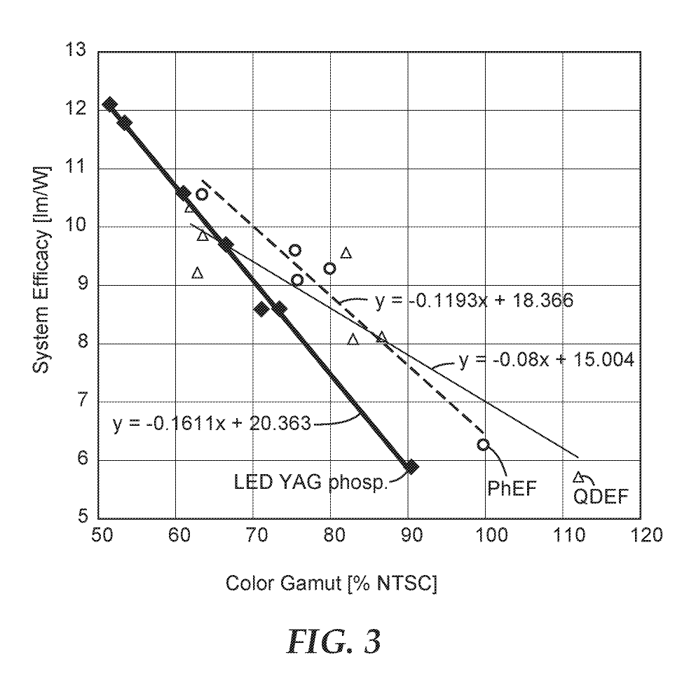

The trade-off between system efficacy and color gamut with the hybrid system was mid-way between the white LED (YAG) system and the full-Cd all-quantum-dot system. More specifically, system efficacy dropped about 0.16 lm/W/% NTSC with a white LED BLU and only about 0.08 lm/W/% NTSC with the full-Cd all quantum dot system—or 50% less. With the hybrid system, system efficacy dropped about 0.12 lm/W/% NTSC—or 25% less than the white LED but 50% more than the full-Cd all quantum dot system. As a result, the standard white LED system was preferred for color gamut targets below about 60%, the hybrid solution was preferred for color gamut targets between about 60% and about 85% while the all quantum dot system was always more efficient for high color gamut targets. Actual cross-over points depended on the IQE of the fluorescers. FIG. 3 shows system efficiency plotted versus color gamut for the YAG, all quantum dot (QDEF) and hybrid (PhEF) systems.

### Example 4

A quantum dot display was modeled as follows. Using the MATLAB software package (available from MathWorks, Natick Mass.) and methods described in the examples of WO 2014/123724 (Benoit et al.), which is herein incorporated by reference, a computer model of the display system was prepared. The system's primary light source was a blue LED. The blue LED illuminated a down-converting film consisting of red- and green-emitting quantum dots, or a hybrid construction containing green quantum dots and red phosphor. The LED and fluorescers (either quantum dots or phosphor) were characterized by their intrinsic full-width-at-half-maximum (FWHM). For the blue LED, FHWM was 18 nm at 445 nm.

The emission wavelengths of the LED and fluorescers were used in optimizations designed to maximize the displayed color gamut. Specifically, the peak wavelengths of the blue LED and quantum dots were optimized (variables) to maximize performance. The peak wavelength, emission FWHM, and emission quantum efficiency (EQE, at 440 nm excitation wavelength) of the phosphor material was fixed at 631 nm, 6.3 nm, and 87%, respectively, as measured for a sample of K₂SiF₆:Mn(+4) prepared according to methods described in A. G. Paulusz, J. Electrochem. Soc. Sol. St. Sci. Technol. 1973, 120, 942-7. The optimization process was constrained to closely approximate or augment an appropriate standard color space (DCI-P3 color space with 96% NTSC color gamut: xb=0.150, yb=0.060, xg=0.265, yg=0.690, xr=0.680, yr=0.320; or Adobe RGB color space with 95.5% NTSC color gamut: xb=0.150, yb=0.060, xg=0.210, yg=0.710, xr=0.640, yr=0.330).

The relative proportion of red and green fluorescers was then tuned to deliver a target white point (D65 white point: xw=0.313, yw=0.329). The model also included two BEF films (3M Brightness Enhancement Films TBEF2-GT and TBEF2-GMv5 available from 3M Company, St. Paul Minn.) positioned above the quantum dot film. One BEF film had prisms running along a horizontal axis and the second had prisms running perpendicularly along the vertical axis. The BEF films were modeled as isosceles prism films with 24 micron pitch. Also included in the stack was a 3M APFv3 reflective polarizer (also available from 3M Company). Then, above the crossed BEF films and reflective polarizer, the model included a standard LCD panel with measured native color gamut of 51%, 54%, 61%, 67%, 71%, 74%, or 90% NTSC. A diffuse low brightness reflector with a thickness of 160 μm was used as a back reflector on the non-emitting side of the display. Electrical-to-optical efficiencies were assumed to be 46% for the blue LED. This figure includes losses due to light scattering back into the die.

Color gamut was calculated as the ratio of the area of the color space of the display (defined by the primaries CIE coordinates xb, yb, xg, yg, xr, yr) to the area of the 1953 color NTSC triangle. The CIE color coordinates of each blue, green and red primaries were calculated using the combined spectra of the backlight unit and the corresponding color filter.

The model was exercised for both Adobe RGB color space and for DCI-P3 color space. The Adobe RGB model used green quantum dots with a FWHM of 31.5 nm at 524 nm, and either red quantum dots with a FWHM of 35.0 nm at 627 nm or red phosphor with FWHM of 6.3 nm at 631 nm. The DCI-P3 model used green quantum dots with a FWHM of 32.3 nm at 534 nm and either red quantum dots with a FWHM of 35 nm at 627 nm or a red phosphor with a FWHM of 6.3 nm at 631 nm. Model results are summarized in Table 4.

Results from the modeling approach discussed above demonstrated that red phosphor—green quantum dot hybrid systems can deliver good performance in a display when combined with a commercially available 74% NTSC panel (measured from an iPad 3 device) with color gamut size >90% of the target gamut color space for both DCI-P3 and Adobe RGB and greater than 90% coverage. Near 100% coverage could be achieved by optimizing the design of the color filters. The narrow emission peak width (small FWHM) possible with the red phosphor of this example offers an advantage in % NTSC values slightly higher than those obtained using red quantum dots.

TABLE 4

| | | Color Gamut | | |
|---|---|---|---|---|
| | | % | % Relative to | % Coverage of |
| Fluorescers | Color Space | NTSC | Target | Target |
| Red QD + | Adobe RGB | 103.3 | 108.1 | 98.0 |
| Green QD | DCI-P3 | 97.0 | 101.0 | 93.2 |
| Red Phs + | Adobe RGB | 106.6 | 111.5 | 98.0 |
| Green QD | DCI-P3 | 99.9 | 104.0 | 93.2 |

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A downconversion film element comprising quantum dots and phosphor, wherein either:
(a) the quantum dots emit a peak red wavelength in a range from 615 to 660 nm and a FWHM of less than 50 nm, and the phosphor emits a peak green wavelength in a range from 515 to 555 nm and a FWHM of less than 80 nm and has an internal fluorescence quantum yield of 75% or greater; or
(b) the quantum dots emit a peak green wavelength in a range from 515 to 555 nm and a FWHM of less than 40 nm, and the phosphor emits a peak red wavelength in a range from 615 to 645 nm and a FWHM of less than 80 nm and has an internal fluorescence quantum yield of 75% or greater.

2. The downconversion film element of claim 1 wherein the film comprises quantum dots emitting a peak red wavelength in a range from 615 to 660 nm and a FWHM of less than 50 nm, and phosphor emitting a peak green wavelength in a range from 515 to 555 nm and a FWHM of less than 80 nm and having an internal fluorescence quantum yield of 75% or greater.

3. The downconversion film element of claim 2 wherein the phosphor is selected from the group consisting of europium-doped orthosilicates, europium-doped strontium thiogallates, europium- and manganese-doped barium magnesium aluminum oxides, rare earth-doped nitridosilicates and combinations thereof.

4. The downconversion film element of claim 1 wherein the film comprises quantum dots emitting a peak green wavelength in a range from 515 to 555 nm and a FWHM of less than 40 nm, and phosphor emitting a peak red wavelength in a range from 615 to 645 nm and a FWHM of less than 80 nm and having an internal fluorescence quantum yield of 75% or greater.

5. The downconversion film element of claim 4 wherein the phosphor is selected from the group consisting of Mn(+4) doped phosphors, europium-doped calcium sulfides, europium(+3)-doped phosphors and combinations thereof.

6. The downconversion film element of claim 1 wherein the film comprises less than 200 pm cadmium.

7. The downconversion film element of claim 6 wherein the film comprises less than 100 ppm cadmium.

8. The downconversion film element of claim 7 wherein the film comprises less than 75 ppm cadmium.

9. An optical construction comprising:
(a) a blue light source emitting blue light having a wavelength in a range from 440 to 460 nm and a FWHM of less than 25 nm;
(b) a liquid crystal display (LCD) panel comprising a set of red, blue and green color filters; and
(c) the downconversion film element of claim 1 optically between the blue light source and the LCD panel.

10. The optical construction of claim 9 wherein the LCD panel has a native color gamut in a range from 35% to 45% NTSC and the optical construction achieves a color gamut of at least 50% NTSC.

11. The optical construction of claim 9 wherein the LCD panel has a native color gamut in a range from 45% to 55% NTSC and the optical construction achieves a color gamut of at least 60% NTSC.

12. The optical construction of claim 9 wherein the LCD panel has a native color gamut in a range from 55% to 65% NTSC and the optical construction achieves a color gamut of at least 70% NTSC.

13. The optical construction of claim 9 wherein the LCD panel has a native color gamut in a range from 65% to 75% NTSC and the optical construction achieves a color gamut of at least 80% NTSC.

14. The optical construction of claim 9 wherein the LCD panel has a native color gamut in a range from 75% to 85% NTSC and the optical construction achieves a color gamut of at least 90% NTSC.

15. The optical construction of claim 9 wherein the LCD panel has a native color gamut in a range from 85% to 95% NTSC and the optical construction achieves a color gamut of at least 100% NTSC.

16. The optical construction of claim 9 further comprising a light recycling element optically between the downconversion film element and the LCD panel.

17. A luminaire comprising:
(a) a blue light source emitting blue light having a wavelength in a range from 440 to 460 nm and a FWHM of less than 25 nm;
(b) an optical component adapted to be optically coupled to the blue light source; and
(c) the downconversion film element of claim 1 disposed adjacent the optical component.

18. The luminaire of claim 17 wherein the optical component is a light guide.
